(19) United States
(12) Patent Application Publication
(10) Pub. No.: US 2026/0083278 A1
(43) Pub. Date: Mar. 26, 2026

(54) SEALED AND WATERPROOF WARMING TRAY

(71) Applicant: ZHONGSHAN JIENUO ELECTRIC TECHNOLOGY CO., LTD., ZHONGSHAN (CN)

(72) Inventor: LIN LI, ZHONGSHAN (CN)

(21) Appl. No.: 19/254,338

(22) Filed: Jun. 30, 2025

(30) Foreign Application Priority Data
Sep. 21, 2024 (CN) 202422304869.7
Sep. 21, 2024 (CN) 202422304870.X
Sep. 21, 2024 (CN) 202422304871.4

(51) Int. Cl. A47J 36/24

(52) U.S. Cl. CPC A47J 36/2483

(57) ABSTRACT

A sealed and waterproof warming tray is provided, including a flexible heating pad, a heating member, and a rigid power connection device. The heating member is disposed in the flexible heating pad, the rigid power connection device is electrically connected to the heating member and is configured to charge the heating member, a sealing structure is disposed between the flexible heating pad and the rigid power connection device, the flexible heating pad and the rigid power connection device are sealingly connected through the sealing structure. The sealed and waterproof warming tray completely seal gaps between an upper housing body and a lower housing body and gaps between a coupling socket and a housing component, thereby preventing water from entering the housing component, effectively protecting internal electronic members of the housing component. In this way, the sealed and waterproof warming tray is capable of being cleaned by water rinsing.

### TECHNICAL FIELD

The present disclosure relates to the field of warming trays, and in particular to a sealed and waterproof warming tray.

### BACKGROUND

A warming tray, also referred to as a food warming board, is capable of maintaining temperature of cooked dishes. Conventional food warming boards are typically made of silicone material and incorporate heating wires or heating films to generate heat to warm food placed thereon.

The conventional food warming boards each includes a flexible heating pad and a housing assembly connected to one end of the flexible heating pad. Electrical components, including a coupling socket, are disposed in the housing assembly, and the housing assembly includes an upper housing and a lower housing connected with each other. However, the conventional food warming boards lack waterproofing capabilities, allowing water infiltration through gaps between the upper housing and lower housing or between the coupling socket and the housing assembly. Such water infiltration risks damaging internal electronic members and complicates cleaning processes due to non-waterproof construction.

In the prior art, Chinese patent No. CN220608163U discloses a food warming board, including at least one board main body. The at least one board main body includes a base, a panel, and a supporting assembly. The panel and the base are enclosed to form an accommodating cavity, the supporting assembly is disposed in the accommodating cavity and spanned between the panel and the base. A first end of the supporting assembly is connected to the base, and a second end of the supporting assembly is connected to the panel. In the Chinese patent No. CN220608163U, the board main body and a controller are integrally formed as a non-separable structure, thereby resulting in inconvenient storage and cleaning.

Additionally, Chinese patent No. CN217744141U discloses a flexible food warming board, including an electronic control device and a flexible board main body. The flexible board main body is fabricated from flexible materials, so that the flexible board main body is capable of being laid flat for use or rolled for storage. An electric heating assembly is disposed in the flexible board main body, including a heating device electrically connected to the electronic control device. The flexible food warming board measures temperature of heating wires through a temperature-sensing probe, however, the temperature-sensing probe is maintained at a distance from the heating wires, leading to inaccuracies in temperature measurements.

### SUMMARY

In order to overcome defects in the prior art, the present disclosure aims to provide a sealed and waterproof warming tray featuring a simple structure, excellent waterproof performance, convenient cleaning, easy storage, enhanced user experience, and strong practicality.

In order to achieve above aims, the present disclosure adopts following technical solutions.

The present disclosure provides the sealed and waterproof warming tray, including a flexible heating pad, a heating member, and a rigid power connection device. The heating member is disposed in the flexible heating pad, the rigid power connection device is electrically connected to the heating member and is configured to charge the heating member, a sealing structure is disposed between the flexible heating pad and the rigid power connection device, the flexible heating pad and the rigid power connection device are sealingly connected through the sealing structure.

Furthermore, the rigid power connection device includes a housing assembly, the sealing structure is a sealing connecting frame disposed on the flexible heating pad, the flexible heating pad and the housing assembly are sealingly connected through the sealing connecting frame. The sealing connecting frame defines a hollowed portion to form an accommodating cavity therein.

Furthermore, the housing assembly includes a housing component and a control box, the flexible heating pad and the housing component are sealingly connected through the sealing connecting frame.

Furthermore, a coupling socket is disposed on the housing component, a sealing sleeve is disposed on the sealing connecting frame, the sealing sleeve is sleeved on a periphery of the coupling socket and is disposed between the housing component and the coupling socket.

Furthermore, the housing component includes an upper housing body and a lower housing body, the upper housing body and the lower housing body are connected with each other, the sealing connecting frame includes a sealing portion. After the upper housing body and the lower housing body are connected, the sealing portion is pressed between the upper housing body and the lower housing body to connect the flexible heating pad and the housing component.

Furthermore, the sealing connecting frame includes a sealing rib, the sealing rib is disposed at an inner side of the sealing portion, the housing component defines an inner cavity, the sealing rib abuts against side walls of the inner cavity, and the sealing rib is respectively sealingly connected to an inner wall of the upper housing body and an inner wall of the lower housing body. The upper housing body defines a slot on a lower side thereof, the lower housing body includes an inserting rib on an upper side thereof, the inserting rib is inserted into the slot, and the inserting rib abuts against a first outer side of the sealing portion. The flexible heating pad includes a limiting protrusion at one end thereof, the limiting protrusion is disposed at a second outer side of the sealing portion, the limiting protrusion and the sealing portion form a limiting groove therebetween, the lower housing body includes a mating edge, and the mating edge is disposed in the limiting groove.

Furthermore, the upper housing body includes a first protruding rib, the lower housing body includes a second protruding rib, the first protruding rib presses against an upper side of the sealing portion, and the second protruding rib presses against a lower side of the sealing portion.

Furthermore, the upper housing body includes first fixing posts, each of the first fixing posts defines a first fixing hole, the lower housing body defines second fixing holes, a fastener passes through a corresponding one of the second fixing holes and engages with a corresponding first fixing hole to connect the upper housing body and the lower housing body. The first fixing posts pass through the sealing connecting frame, and the first fixing posts and the second fixing holes are disposed in the accommodating cavity. The lower housing body further includes limiting ribs. The sealing rib is clamped between inner side walls of the housing component, the limiting ribs, and the first fixing posts.

Furthermore, the sealing sleeve is pressed between the upper housing body and the lower housing body, the sealing sleeve includes an upper sleeve body and a lower sleeve body, a first mounting hole is formed between the first upper sleeve body and the lower sleeve body, and the first mounting hole is configured to accommodate the coupling socket. The upper housing body defines a first positioning groove, the lower housing body defines a second positioning groove, the upper sleeve body is disposed in the first positioning groove, and the lower sleeve body is disposed in the second positioning groove.

Furthermore, the lower sleeve body defines a positioning notch, the coupling socket includes a positioning rib, the positioning rib is engaged with the positioning notch.

Furthermore, the control box includes a control board and a coupling plug, the coupling socket is electrically connected to the coupling plug and forms conductive contact therewith, the coupling plug is electrically connected to the control board, and the control board is connected to an external power supply through a power cord. A thermal protector and a temperature sensor are disposed in the inner cavity of the housing component, a heating film is disposed in the flexible heating pad, and the heating film is the heating member, the coupling socket is respectively electrically connected to the thermal protector, the temperature sensor, and the heating film. The heating member is disposed above or below the thermal protector and the temperature sensor.

Furthermore, the coupling socket includes electrical terminals, the coupling plug includes electrical contact portions, the electrical terminals are inserted into and electrically connected to the electrical contact portions.

Furthermore, the upper housing body and the lower housing body defines a second mounting hole therebetween, the second mounting hole is disposed corresponding to the first mounting hole, the second mounting hole is configured to accommodate the coupling socket. The control box defines a third mounting hole corresponding to the second mounting hole, and the third mounting hole is configured to accommodate the coupling plug.

Furthermore, the heating member includes at least one wiring terminal, the at least one wiring terminal extends into the inner cavity of the housing component, and first wiring extending externally from the at least one wiring terminal is electrically connected to the coupling socket.

Furthermore, the inner cavity includes at least one second fixing post, a thermal insulation member is sleeved on the at least one second fixing post, the thermal insulation member is disposed between the at least one wiring terminal and the at least one second fixing post to separate the at least one wiring terminal and the at least one second fixing post. A connecting portion is disposed between the at least one wiring terminal, the thermal insulation member, and the at least one second fixing post, and the connecting portion is configured to connect the at least one wiring terminal, the thermal insulation member, and the at least one second fixing post. The connecting portion includes a third fixing hole defined on the at least one wiring terminal, a fourth fixing hole defined on the thermal insulation member, and a fifth fixing hole defined on the at least one second fixing post, a screw sequentially passes through the third fixing hole and fourth fixing hole to fixedly connect to the fifth fixing hole, so as to connect the at least one wiring terminal, the thermal insulation member, and the at least one second fixing post.

Furthermore, the flexible heating pad defines a fourth mounting hole and a fifth mounting hole, the temperature sensor is disposed in the fourth mounting hole, and the thermal protector is disposed in the fifth mounting hole. The heating member is disposed above the thermal protector and the temperature sensor, the thermal protector and the temperature sensor are pressed into the heating member to a depth of a, where the a ranged from 0.8 mm to 1.5 mm.

Furthermore, the coupling socket and the coupling plug form a coupling portion, the coupling portion is partially disposed in the inner cavity, the fourth mounting hole is communicated with the inner cavity, the temperature sensor partially extends into the inner cavity, first connection terminals extend from one end, extending into the inner cavity, of the temperature sensor, and first wiring extending externally from the first connection terminals is electrically connected to coupling portion.

Furthermore, second connection terminals are disposed on the thermal protector, the fifth mounting hole is communicated with the inner cavity, the second connection terminals extend into the inner cavity, and second wiring extending externally from the second connection terminals is respectively electrically connected to the coupling portion and the heating member.

Furthermore, the flexible heating pad includes a protruding portion, the fourth mounting hole and the fifth mounting hole are defined on the protruding portion, the housing component defines a limiting hole, the protruding portion passes through the limiting hole and extends into the inner cavity.

Furthermore, the flexible heating pad includes a planar heating pad body, the heating member is disposed in the planar heating pad body, a thickness of the planar heating pad body is b, and the b is ranged from 2 mm to 4 mm. The heating member is a carbon crystal heating film, the carbon crystal heating film is sheet-shaped and has a thickness less than 30 μm.

Compared to the prior art, beneficial effects of the present disclosure are as following.

According to the sealed and waterproof warming tray of the present disclosure, the sealing structure is disposed between the flexible heating pad and the rigid power connection device to sealingly connect the flexible heating pad and the rigid power connection device. Specifically, the flexible heating pad and the housing component of the rigid power connection device are sealingly connected through the sealing connecting frame, the sealing connecting frame includes the sealing portion, and the sealing portion is pressed between the upper housing body and the lower housing body. The sealing connecting frame includes the sealing rib, the sealing rib is disposed at the inner side of the sealing portion. Moreover, the sealing sleeve is disposed on the sealing connecting frame, the sealing sleeve is sleeved on the periphery of the coupling socket and is disposed between the housing component and the coupling socket. Such structure completely seal gaps between the upper housing body and the lower housing body and gaps between the coupling socket and the housing component, thereby preventing water from entering the housing component, effectively protecting internal electronic members of the housing component. In this way, the sealed and waterproof warming tray is capable of being cleaned by water rinsing. Moreover, the water is prevented from entering the housing component even when the sealed and waterproof warming tray is immersed in water under pressure. Therefore, the sealed and waterproof warming tray provided in the present disclosure is also capable of being cleaned by submersion, which is highly convenient for cleaning.

Furthermore, the coupling portion formed by the coupling socket and the coupling plug is disposed between the flexible heating pad and the rigid power connection device, so as to form detachable electrical connection between the housing component and the control box. In this way, the flexible heating pad and the control box that are connected to the housing component are detachable, which is convenient for storage and cleaning of the sealed and waterproof warming tray. Moreover, the sealing sleeve is disposed on the sealing connecting frame, the sealing sleeve is sleeved on the periphery of the coupling socket and is disposed between the housing component and the coupling socket to seal the gaps between the coupling socket and the housing component, thereby preventing the water from entering the housing component, effectively protecting internal electronic members of the housing component.

Furthermore, the heating member is disposed above or below the thermal protector and the temperature sensor, the thermal protector and the temperature sensor are pressed into the heating member to a depth ranged from 0.8 mm to 1.5 mm. In addition, the heating member is implemented as the heating film, ensuring full contact between both the temperature sensor/thermal protector and the heating film, thereby further improving measurement accuracy. The heating member is the carbon crystal heating film, the carbon crystal heating film is sheet-shaped and thin, thereby enabling more uniform heat generation across the heating film to further enabling more even food heating.

### BRIEF DESCRIPTION OF DRAWINGS

In order to more clearly illustrate technical solutions in embodiments of the present disclosure, accompanying drawings required in description of the embodiments are briefly described below, and obviously, the accompanying drawings in the following description are merely some embodiments of the present disclosure, and for those who skilled in the art, other drawings may be obtained according to these accompanying drawings without creative efforts.

FIG. 1 is an exploded cross-sectional structural schematic diagram of a sealed and waterproof warming tray according to one embodiment the present disclosure.

FIG. 2 is a cross-sectional schematic diagram of partial structures of the sealed and waterproof warming tray taken along the line G-G shown in FIG. 27.

FIG. 3 is an enlarged schematic diagram of portion A shown in FIG. 2.

FIG. 4 is a cross-sectional schematic diagram of the sealed and waterproof warming tray taken from the line H-H shown in FIG. 27.

FIG. 5 is an enlarged schematic diagram of portion B shown in FIG. 4.

FIG. 6 is a partial structural schematic diagram of the flexible heating pad according to one embodiment of the present disclosure.

FIG. 7 is a partial exploded structural schematic diagram of the sealed and waterproof warming tray according to one embodiment of the present disclosure.

FIG. 8 is an overall structural schematic diagram of the sealed and waterproof warming tray according to one embodiment of the present disclosure.

FIG. 9 is an overall structural schematic diagram of an upper housing body according to one embodiment of the present disclosure.

FIG. 10 is an overall structural schematic diagram of a lower housing body according to one embodiment of the present disclosure.

FIG. 11 is an exploded structural schematic diagram of the sealed and waterproof warming tray according to one embodiment of the present disclosure.

FIG. 12 is an overall structural schematic diagram of the flexible heating pad according to one embodiment of the present disclosure.

FIG. 13 is an exploded structural schematic diagram of a control box according to one embodiment of the present disclosure.

FIG. 14 is a cross-sectional schematic diagram of the sealed and waterproof warming tray taken along the line G-G shown in FIG. 27.

FIG. 15 is an enlarged schematic diagram of portion C shown in FIG. 14.

FIG. 16 is an exploded structural schematic diagram of the control box and a coupling portion according to one embodiment of the present disclosure.

FIG. 17 is a partial structural schematic diagram of the sealed and waterproof warming tray according to one embodiment of the present disclosure.

FIG. 18 is a partial exploded structural schematic diagram of the sealed and waterproof warming tray taken from another orientation according to one embodiment of the present disclosure.

FIG. 19 is a cross-sectional schematic diagram of the sealed and waterproof warming tray taken along the line I-I shown in FIG. 27.

FIG. 20 is an enlarged schematic diagram of portion D shown in FIG. 19.

FIG. 21 is an oblique cross-sectional schematic diagram of partial structures of the sealed and waterproof warming tray taken along the line I-I shown in FIG. 27.

FIG. 22 is an enlarged schematic diagram of portion E shown in FIG. 21.

FIG. 23 is a partial exploded structural schematic diagram of the sealed and waterproof warming tray according to one embodiment of the present disclosure.

FIG. 24 is an enlarged schematic diagram of portion F shown in FIG. 23.

FIG. 25 is a partial exploded structural schematic diagram of the sealed and waterproof warming tray taken from another orientation according to one embodiment of the present disclosure.

FIG. 26 is a structural schematic diagram of the flexible heating pad according to one embodiment of the present disclosure.

FIG. 27 is a structural schematic diagram illustrating a top plan view of the sealed and waterproof warming tray according to one embodiment of the present disclosure.

### DETAILED DESCRIPTION OF EMBODIMENTS

In order to make technical problems, technical solutions, and beneficial effects to be solved by the present disclosure clearer, the present disclosure is further described in detail below with reference to embodiments. It should be understood that specific embodiments described herein are only used to explain the present disclosure and are not intended to limit the present disclosure.

The following describes in combination with specific embodiments.

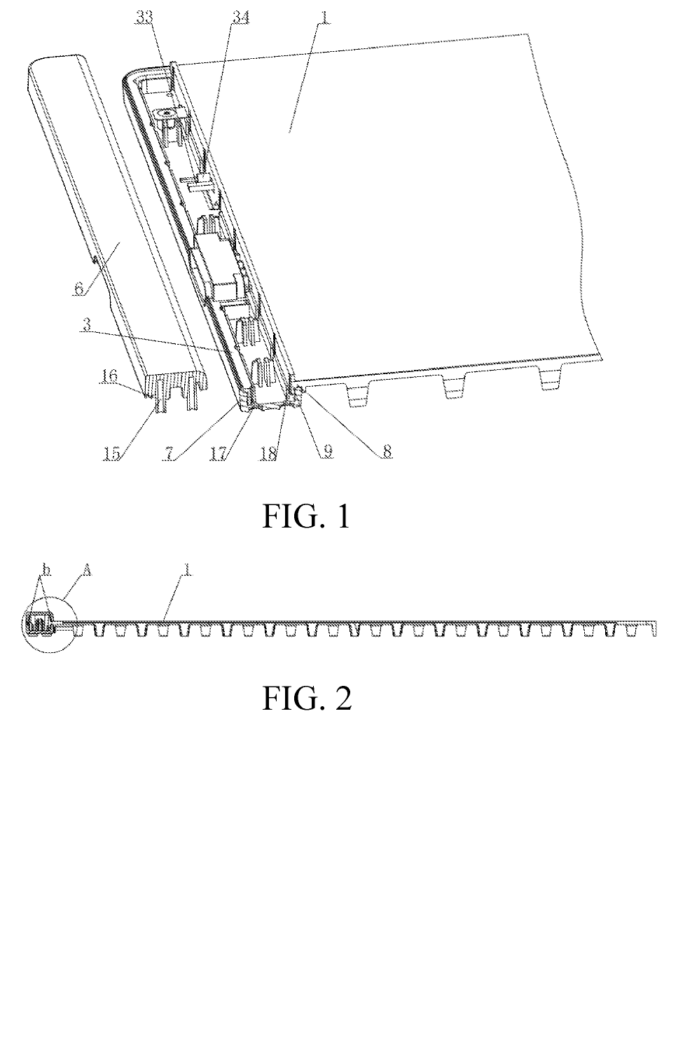

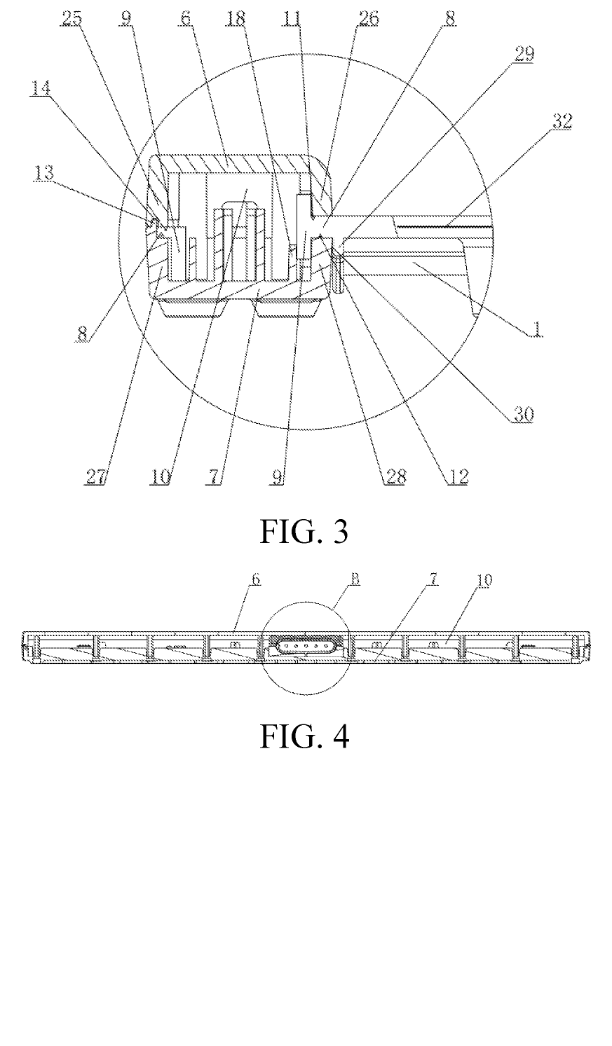

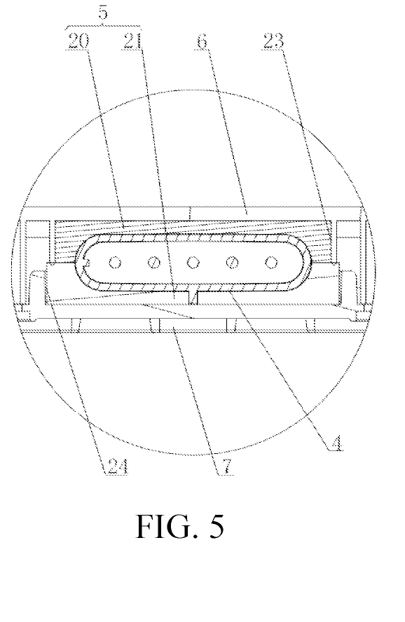

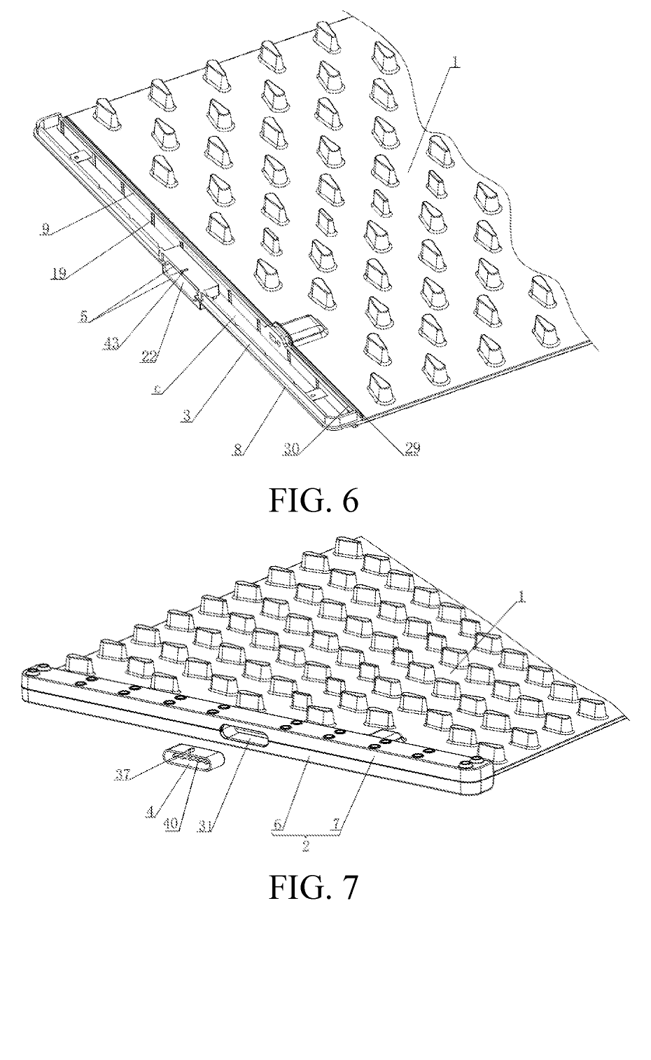

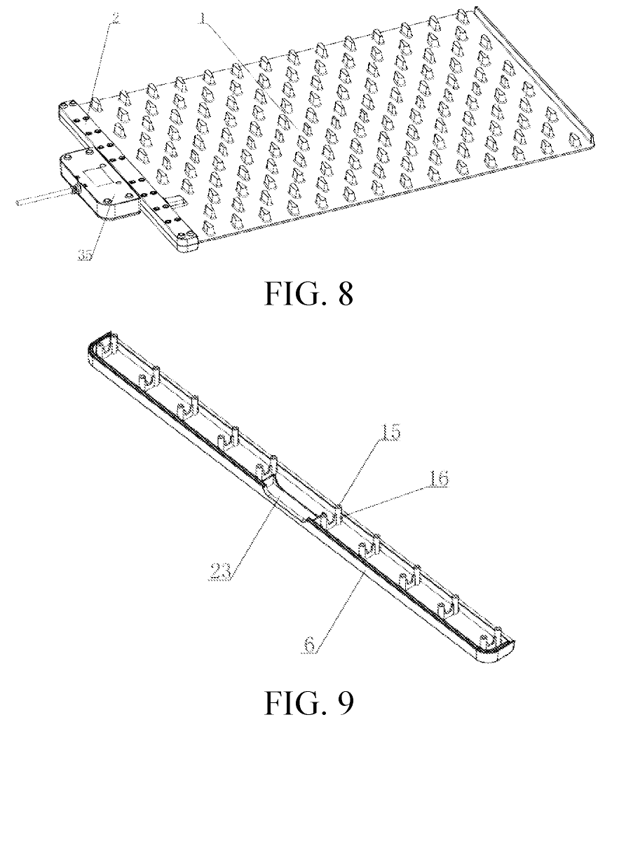

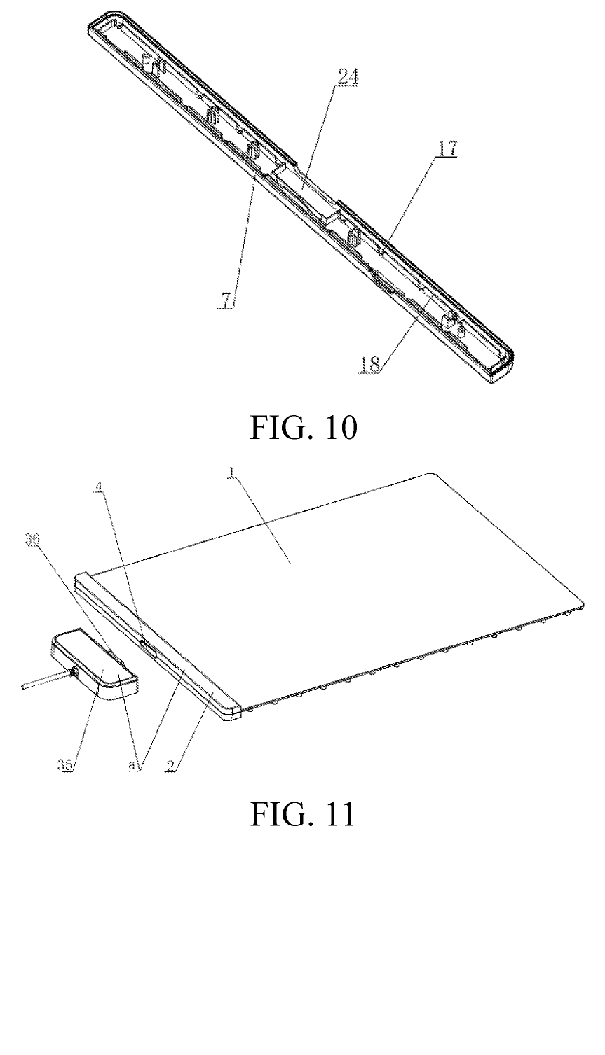

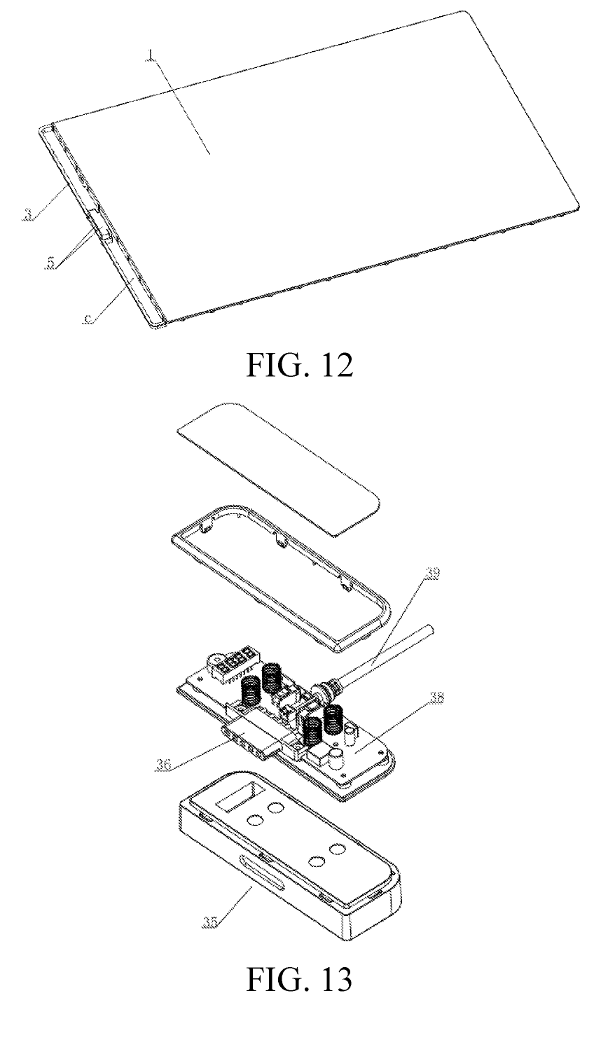

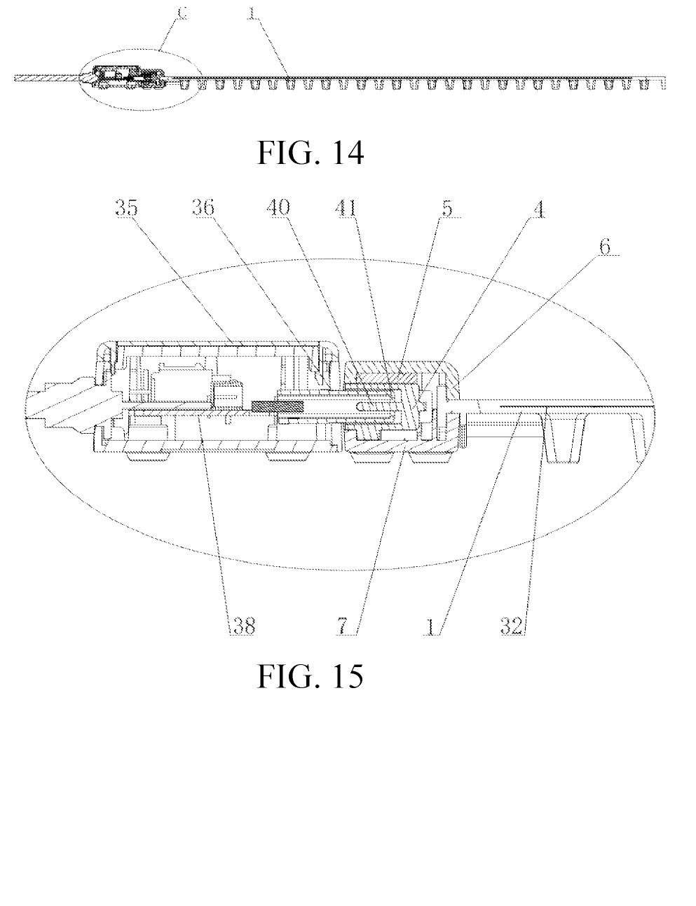

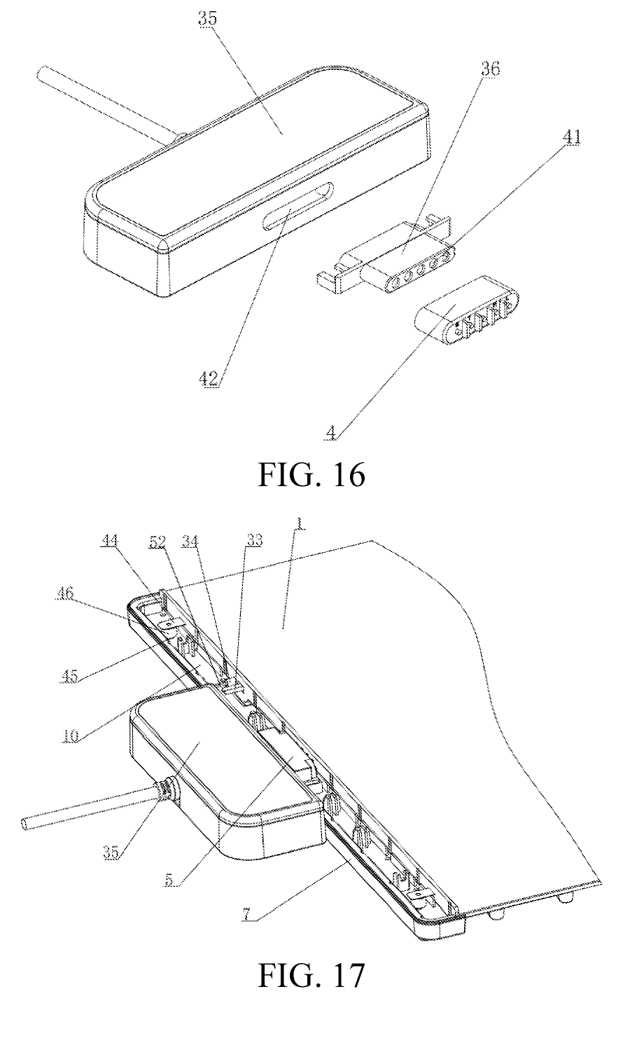

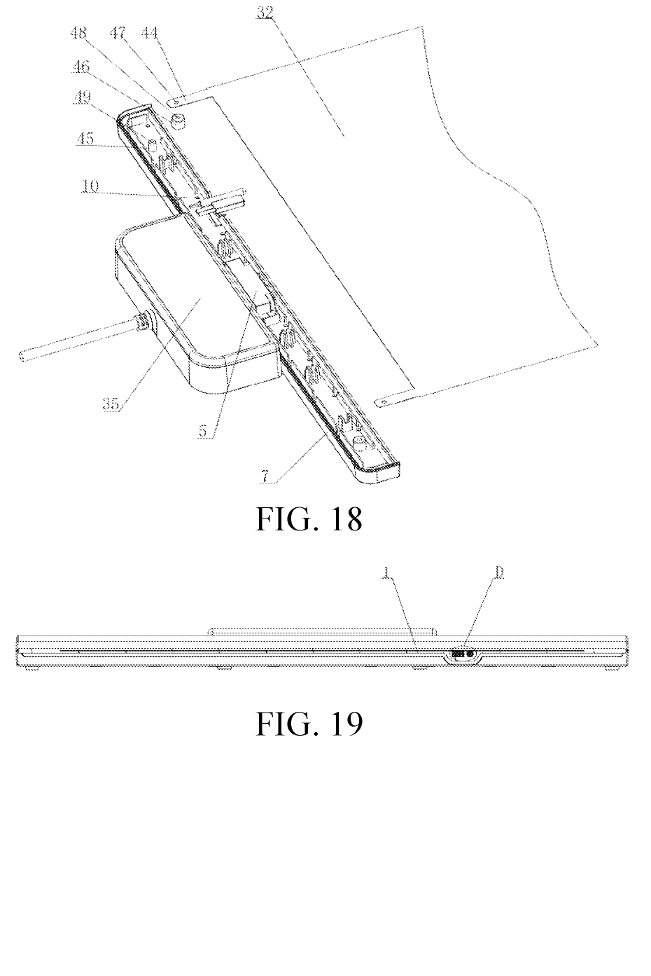

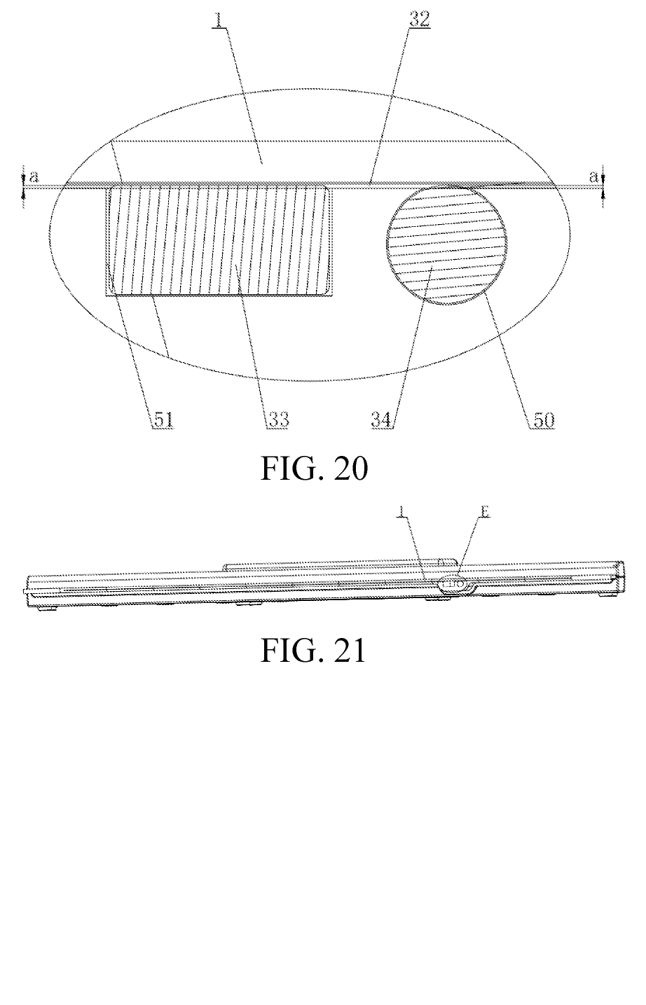

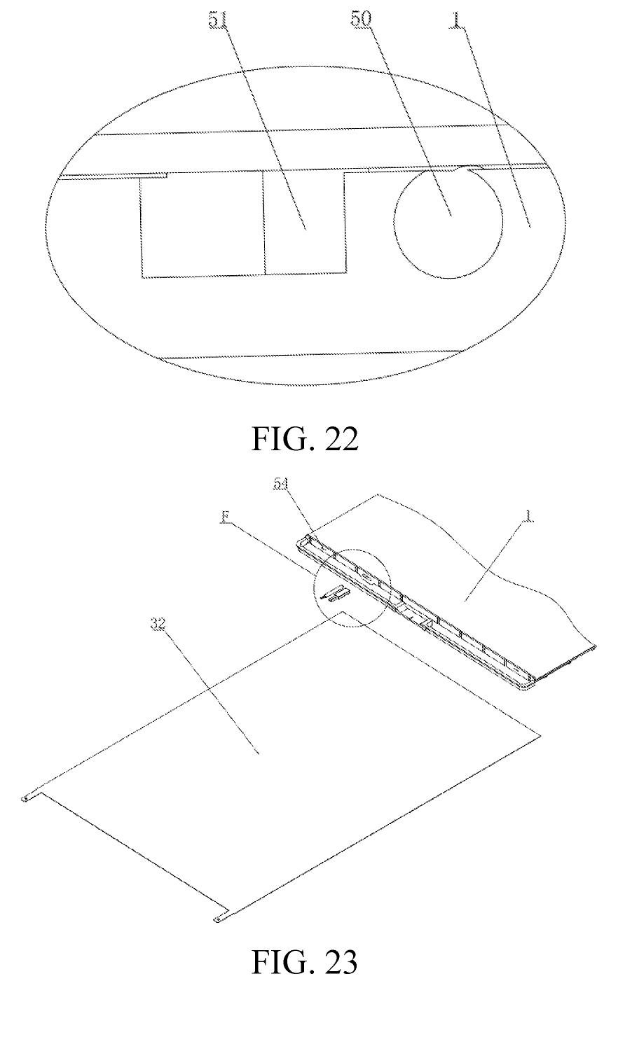

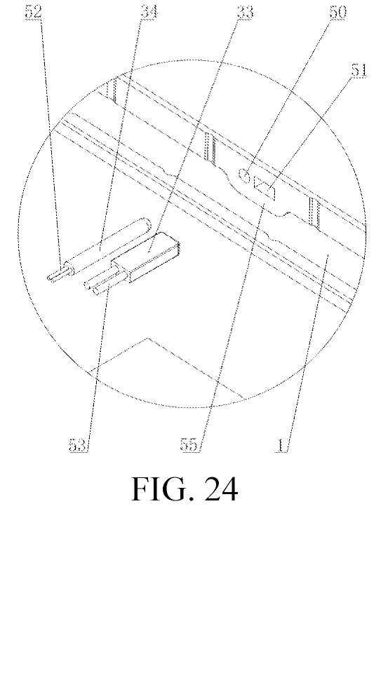

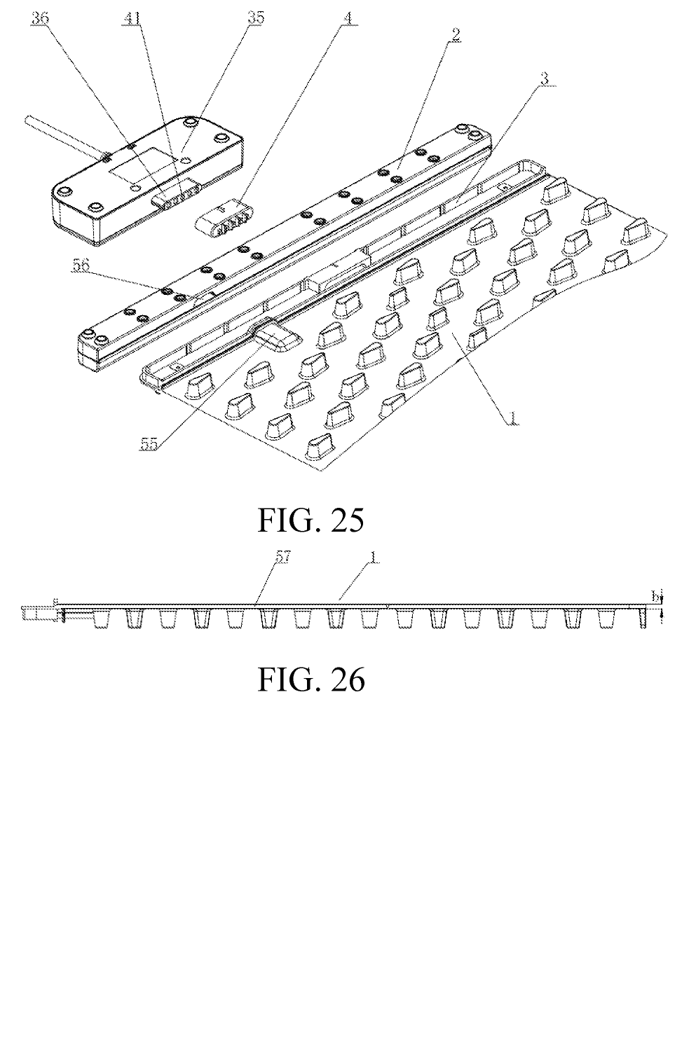

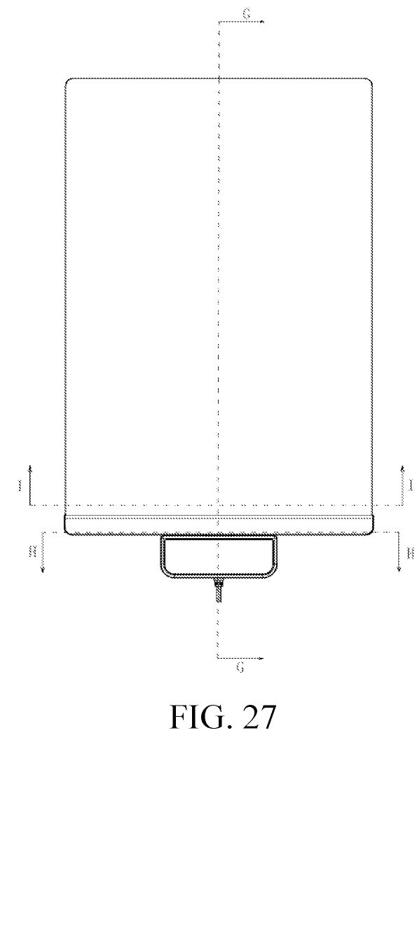

Referring to FIGS. 1-27, The present disclosure provides the sealed and waterproof warming tray, including a flexible heating pad 1, a heating member 32, and a rigid power connection device v. The heating member 32 is disposed in the flexible heating pad 1, the rigid power connection device v is electrically connected to the heating member 32 and is configured to charge the heating member 32, a sealing structure b is disposed between the flexible heating pad 1 and the rigid power connection device v, the flexible heating pad 1 and the rigid power connection device v are sealingly connected through the sealing structure b.

Furthermore, the rigid power connection device v includes a housing assembly, the sealing structure b is a sealing connecting frame 3 disposed on the flexible heating pad 1, the flexible heating pad 1 and the housing assembly are sealingly connected through the sealing connecting frame 3. The sealing connecting frame 3 defines a hollowed portion to form an accommodating cavity c therein. The accommodating cavity c is configured to allow passage of wiring, to accommodate first fixing posts 16 and second fixing holes 17 for mounting of an upper housing body 6 and a lower housing body 7, and to accommodate electronic members, such as a thermal protector 33 and a temperature sensor 34.

Furthermore, the housing assembly includes a housing component 2 and a control box 35, the flexible heating pad 1 and the housing component 2 are sealingly connected through the sealing connecting frame 3.

Furthermore, a coupling socket 4 is disposed on the housing component 2, a sealing sleeve 5 is disposed on the sealing connecting frame 3, the sealing sleeve 5 is sleeved on a periphery of the coupling socket 4 and is disposed between the housing component 2 and the coupling socket 4 to seal gaps between the coupling socket 4 and the housing component 2.

Furthermore, the housing component 2 includes an upper housing body 6 and a lower housing body 7, the upper housing body 6 and the lower housing body 7 are connected with each other, the sealing connecting frame 3 includes a sealing portion 8 disposed around a periphery thereof. After the upper housing body 6 and the lower housing body 7 are connected, the sealing portion 8 is pressed between the upper housing body 6 and the lower housing body 7 to connect the flexible heating pad 1 and the housing component 2. The sealing portion 8 not only seals gaps between the upper housing body 6 and the lower housing body 7, but also provides a full perimeter seal for the housing component 2.

Furthermore, the sealing connecting frame 3 includes a sealing rib 9, the sealing rib 9 is disposed at an inner side of the sealing portion 8, the housing component 2 defines an inner cavity 10, the sealing rib 9 abuts against side walls of the inner cavity 10, and the sealing rib 9 is respectively sealingly connected to an inner wall of the upper housing body 6 and an inner wall of the lower housing body 7. The sealing rib 9 is configured to limit the flexible heating pad 1 to prevent the flexible heating pad 1 from front, rear, left, or right displacement relative to the housing component 2, thereby further preventing loosening of connection between the flexible heating pad 1 and the housing component 2. Additionally, the sealing rib 9 enhances sealing between the upper housing body 6 and lower housing body 7. Even if water penetrates through the sealing portion 8, the water is still blocked by the sealing rib 9 from entering the inner cavity 10 of the housing component 2.

Furthermore, the upper housing body 6 includes a first protruding rib 11 on a lower side thereof, the lower housing body 7 includes a second protruding rib 12 on an upper side thereof, the first protruding rib 11 presses against an upper side of the sealing portion 8, and the second protruding rib 12 presses against a lower side of the sealing portion 8. The first protruding rib 11 enhances tight engagement between the upper housing body 6 and the sealing portion 8, and the second protruding rib 12 enhances tight engagement between the lower housing body 7 and the sealing portion 8, thereby further improving sealing between the upper housing body 6 and lower housing body 7.

The upper housing body 6 defines a slot 14 on the lower side thereof, the lower housing body 7 includes an inserting rib 13 on the upper side thereof, the inserting rib 13 is inserted into the slot 14, and the inserting rib 13 abuts against a first outer side of the sealing portion 8. Such engagement between the inserting rib 13 and slot 14 further enhances sealing between the upper housing body 6 and lower housing body 7.

The upper housing body 6 includes a first mating edge 25 at a first side thereof and a second mating edge 26 at a second side thereof. The lower housing body 7 includes a third mating edge 27 at a first side thereof and a fourth mating edge 28 at a second side thereof. The slot 14 is defined at a lower end of the first mating edge 25, and the inserting rib 13 is disposed at an upper end of the third mating edge 27. The flexible heating pad 1 includes a limiting protrusion 29 at one end thereof, the limiting protrusion 29 is disposed at a second outer side of the sealing portion 8, the limiting protrusion 29 and the sealing portion 9 form a limiting groove 30 therebetween, and the fourth mating edge 28 is disposed in the limiting groove 30, in this way, the flexible heating pad 1 is prevented from left-right displacement relative to the housing component 2. Moreover, the limiting protrusion 29 serves as a sealing feature that prevents the water from entering the housing component 2 and further enhances both mounting stability and sealing performance between the sealing connecting frame 3 and the housing component 2.

The first protruding rib 11 is disposed at a lower end of each of the first mating edge 25 and the second mating edge 26, and the second protruding rib 12 is disposed at an upper end of each of the third mating edge 27 and the fourth mating edge 28.

Furthermore, the upper housing body 6 includes first fixing posts 16, each of the first fixing posts 16 defines a first fixing hole 15, the lower housing body 7 defines second fixing holes 17, a fastener, such as a screw, passes through a corresponding one of the second fixing holes 17 and engages with a corresponding first fixing hole 15 to connect the upper housing body 6 and the lower housing body 7. The first fixing posts 16 pass through the sealing connecting frame 3, and the first fixing posts 16 and the second fixing holes 17 are disposed in the accommodating cavity c.

The lower housing body 7 further includes limiting ribs 18. The sealing rib 9 is clamped between inner side walls of the housing component 2, the limiting ribs, and the first fixing posts, where the inner side walls of the housing component 2 are side walls of the inner cavity, that is, a side wall of the third mating edge 27 or a side wall of the fourth mating edge 28. In this way, the flexible heating pad 1 is further prevented from front, rear, left, or right displacement relative to the housing component 2. The sealing rib 9 includes recessing portions 19 for matching with the first fixing posts 16.

Furthermore, the sealing sleeve 5 is pressed between the upper housing body 6 and the lower housing body 7, the sealing sleeve 5 includes an upper sleeve body 20 and a lower sleeve body 21, the upper sleeve body 20 and the lower sleeve body 21 are integrated or separately disposed. In the embodiments, the upper sleeve body 20 and the lower sleeve body 21 are separately disposed. The lower sleeve body 21 is integrated on the sealing connecting frame 3, the upper sleeve body 20 is separate the sealing connecting frame 3. A first mounting hole 22 is formed between the first upper sleeve body 20 and the lower sleeve body 21, and the first mounting hole 22 is configured to accommodate the coupling socket 4. The upper housing body 6 and the lower housing body 7 defines a second mounting hole 31 therebetween, the second mounting hole 31 is disposed corresponding to the first mounting hole 22, the second mounting hole 31 is configured to accommodate the coupling socket 4. The control box 35 defines a third mounting hole 42 corresponding to the second mounting hole 31, and the third mounting hole 42 is configured to accommodate a coupling plug 36. The upper housing body 6 defines a first positioning groove 23, the lower housing body 7 defines a second positioning groove 24, the upper sleeve body 20 is disposed in the first positioning groove 23, and the lower sleeve body 21 is disposed in the second positioning groove 24. The first positioning groove 23 and the second positioning groove 24 prevent loosening of the upper sleeve body 20 and the lower sleeve body 21, thereby avoiding degradation of sealing performance of the sealing sleeve 5.

Furthermore, the lower sleeve body 21 defines a positioning notch 43, the coupling socket 4 includes a positioning rib 37, the positioning rib 37 is engaged with the positioning notch 43. Such structure positively locates the coupling socket 4 and prevents the coupling socket 4 from disengaging from the second mounting hole 31.

The flexible heating pad 1 is made of silicone material, and the housing component 2 is made of plastic.

Furthermore, the control box 35 includes a control board 38 and the coupling plug 36, the coupling socket 4 is electrically connected to the coupling plug 36 and forms conductive contact therewith, so as to achieving detachable electric connection between the housing component 2 and the control box 35. The coupling plug 36 is electrically connected to the control board 38, and the control board 38 is connected to an external power supply through a power cord 39. A thermal protector 33 and a temperature sensor 34 are disposed in the inner cavity 10 of the housing component 2, the temperature sensor 34 is a Negative Temperature Coefficient (NTC) temperature sensor, a heating film 32 is disposed in the flexible heating pad 1, and the heating film 32 is the heating member 32, the coupling socket 4 is respectively electrically connected to the thermal protector 33, the temperature sensor 34, and the heating film 32. Specifically, the temperature sensor is configured to detect a temperature of the heating member 32 and transmit a signal to the control board 38, the control board 38 is configured to adjust an operation of the heating member 32 to regulate a surface temperature of the flexible heating pad 1.

Furthermore, the heating member 32 includes at least one wiring terminal 44, the at least one wiring terminal 44 extends into the inner cavity 10 of the housing component 2, and first wiring extending externally from the at least one wiring terminal 44 is electrically connected to a connection terminal of the coupling socket 4 for charging the heating member 32. The at least one wiring terminal 44 serves as a conductive input terminal, when two wiring terminals 44 are provided, two conductive input terminals are respectively a positive conductive copper foil and a negative conductive copper foil, The heating member 32 is a carbon crystal heating film. The at least one wiring terminal 44 extends into the inner cavity 10, facilitating connection with the coupling socket 4, thereby charging the heating member 32 and controlling the heating member 32. Specifically, two wiring terminals 44 are provided and are respectively disposed at two sides of the heating member 32, and the two wiring terminals 44 are respectively a positive electrode of the heating member 32 and a negative electrode of the heating member 32.

Furthermore, the coupling socket 4 includes electrical terminals 40, the coupling plug 36 includes electrical contact portions 41, the electrical terminals 40 are inserted into and electrically connected to the electrical contact portions 41. The electrical terminals 40 serve as electrodes, the electrical contact portions 41 serve as socket holes, the coupling socket 4 and the coupling plug 36 form a coupling portion, the coupling portion is a five-in coupler. Specifically, five electrical terminals 40 and five electrical contact portions 41 are provided.

Furthermore, the inner cavity 10 includes at least one second fixing post 45, a thermal insulation member 46 is sleeved on the at least one second fixing post 45, the thermal insulation member 46 is disposed between the at least one wiring terminal 44 and the at least one second fixing post 45 to separate the at least one wiring terminal 44 and the at least one second fixing post 45. A connecting portion is disposed between the at least one wiring terminal 44, the thermal insulation member 46, and the at least one second fixing post 45, and the connecting portion is configured to connect the at least one wiring terminal 44, the thermal insulation member 46, and the at least one second fixing post 45. The connecting portion includes a third fixing hole 47 defined on the at least one wiring terminal 44, a fourth fixing hole 48 defined on the thermal insulation member 46, and a fifth fixing hole 49 defined on the at least one second fixing post 45, a screw sequentially passes through the third fixing hole 47 and fourth fixing hole 48 to fixedly connect to the fifth fixing hole 49, so as to connect the at least one wiring terminal 44, the thermal insulation member 46, and the at least one second fixing post 45.

Furthermore, the flexible heating pad 1 defines a fourth mounting hole 50 and a fifth mounting hole 51, the temperature sensor 34 is disposed in the fourth mounting hole 50, and the thermal protector 33 is disposed in the fifth mounting hole 51. The heating member 32 is disposed above or below the thermal protector 33 and the temperature sensor 34. In the embodiments, the heating member 32 is disposed above the thermal protector 33 and the temperature sensor 34, the thermal protector 33 and the temperature sensor 34 are pressed into the heating member 32 to a depth of a, where the a is ranged from 0.8 mm to 1.5 mm. In the embodiments, the a is equal to 1 mm.

Furthermore, the coupling socket 4 and the coupling plug 36 form the coupling portion, the coupling portion is partially disposed in the inner cavity 10, the fourth mounting hole 50 is communicated with the inner cavity 10, the temperature sensor 34 partially extends into the inner cavity 10, first connection terminals 52 extend from one end, extending into the inner cavity 10, of the temperature sensor 34, and first wiring extending externally from the first connection terminals 52 is electrically connected to coupling socket 4.

Furthermore, second connection terminals 53 are disposed on the thermal protector 33, the fifth mounting hole 51 is communicated with the inner cavity 10, the second connection terminals 53 extend into the inner cavity 10, and second wiring extending externally from the second connection terminals 53 is respectively electrically connected to the coupling portion 4 and the heating member 32. The thermal protector 33 serves as a temperature switch. If the temperature sensor 34 fails to properly measure temperature and a temperature of the heating member 32 rises to exceed a preset trip temperature of the temperature switch, the temperature switch opens to deactivate the heating member 32.

The first connection terminals 52 and the second connection terminals 53 are disposed in the inner cavity 10, which is convenient for electrically connecting to the coupling socket 4.

Furthermore, the flexible heating pad 1 includes a protruding portion 55, the fourth mounting hole 50 and the fifth mounting hole 51 are defined on the protruding portion 55, the housing component 2 defines a limiting hole 56, the protruding portion 55 passes through the limiting hole 56 and extends into the inner cavity 10, so as to communicate the fourth mounting hole 50 and the fifth mounting hole 51 with the inner cavity 10.

Furthermore, the flexible heating pad 1 includes a planar heating pad body 57, the heating member 32 is disposed in the planar heating pad body 57, a thickness of the planar heating pad body 57 is b, and the b is ranged from 2 mm to 4 mm. In the embodiments, the b is equal to 3 mm. The heating member 32 is the carbon crystal heating film, the carbon crystal heating film is sheet-shaped, the flexible heating pad 1 is made of the silicone material. After vulcanization, the carbon crystal heating film is integrated with the silicone material and has a thickness less than 30 μm.

The foregoing describes only preferred embodiments of the present disclosure and is not intended to limit a scope of the present disclosure. Any modifications, equivalent replacements, and improvements made within spirit and principles of the present disclosure shall fall within a protection scope of the present disclosure.

What is claimed is:

1. A sealed and waterproof warming tray, comprising:
a flexible heating pad;
a heating member; and
a rigid power connection device;
wherein the heating member is disposed in the flexible heating pad, the rigid power connection device is electrically connected to the heating member and is configured to charge the heating member, a sealing structure is disposed between the flexible heating pad and the rigid power connection device, the flexible heating pad and the rigid power connection device are sealingly connected through the sealing structure.

2. The sealed and waterproof warming tray according to claim 1, wherein the rigid power connection device comprises a housing assembly, the sealing structure is a sealing connecting frame disposed on the flexible heating pad, the flexible heating pad and the housing assembly are sealingly connected through the sealing connecting frame; and
the sealing connecting frame defines a hollowed portion to form an accommodating cavity therein.

3. The sealed and waterproof warming tray according to claim 2, wherein the housing assembly comprises a housing component and a control box, the flexible heating pad and the housing component are sealingly connected through the sealing connecting frame.

4. The sealed and waterproof warming tray according to claim 3, wherein a coupling socket is disposed on the housing component, a sealing sleeve is disposed on the sealing connecting frame, the sealing sleeve is sleeved on a periphery of the coupling socket and is disposed between the housing component and the coupling socket.

5. The sealed and waterproof warming tray according to claim 4, wherein the housing component comprises an upper housing body and a lower housing body, the upper housing body and the lower housing body are connected with each other, the sealing connecting frame comprises a sealing portion; and
after the upper housing body and the lower housing body are connected, the sealing portion is pressed between the upper housing body and the lower housing body to connect the flexible heating pad and the housing component.

6. The sealed and waterproof warming tray according to claim 5, wherein the sealing connecting frame comprises a sealing rib, the sealing rib is disposed at an inner side of the sealing portion, the housing component defines an inner cavity, the sealing rib abuts against side walls of the inner cavity, and the sealing rib is respectively sealingly connected to an inner wall of the upper housing body and an inner wall of the lower housing body;
the upper housing body defines a slot on a lower side thereof, the lower housing body comprises an inserting rib on an upper side thereof, the inserting rib is inserted into the slot, and the inserting rib abuts against a first outer side of the sealing portion; and
the flexible heating pad comprises a limiting protrusion at one end thereof, the limiting protrusion is disposed at a second outer side of the sealing portion, the limiting protrusion and the sealing portion form a limiting groove therebetween, the lower housing body comprises a mating edge, and the mating edge is disposed in the limiting groove.

7. The sealed and waterproof warming tray according to claim 5, wherein the upper housing body comprises a first protruding rib, the lower housing body comprises a second protruding rib, the first protruding rib presses against an upper side of the sealing portion, and the second protruding rib presses against a lower side of the sealing portion.

8. The sealed and waterproof warming tray according to claim 5, wherein the upper housing body comprises first fixing posts, each of the first fixing posts defines a first fixing hole, the lower housing body defines second fixing holes, a fastener passes through a corresponding one of the second fixing holes and engages with a corresponding first fixing hole to connect the upper housing body and the lower housing body;
the first fixing posts pass through the sealing connecting frame, and the first fixing posts and the second fixing holes are disposed in the accommodating cavity;
the lower housing body further comprises limiting ribs; and
the sealing rib is clamped between inner side walls of the housing component, the limiting ribs, and the first fixing posts.

9. The sealed and waterproof warming tray according to claim 6, wherein the sealing sleeve is pressed between the upper housing body and the lower housing body, the sealing sleeve comprises an upper sleeve body and a lower sleeve body, a first mounting hole is formed between the first upper sleeve body and the lower sleeve body, and the first mounting hole is configured to accommodate the coupling socket;
the upper housing body defines a first positioning groove, the lower housing body defines a second positioning groove, the upper sleeve body is disposed in the first positioning groove, and the lower sleeve body is disposed in the second positioning groove.

10. The sealed and waterproof warming tray according to claim 9, wherein the lower sleeve body defines a positioning notch, the coupling socket comprises a positioning rib, the positioning rib is engaged with the positioning notch.

11. The sealed and waterproof warming tray according to claim 9, wherein the control box comprises a control board and a coupling plug, the coupling socket is electrically connected to the coupling plug and forms conductive contact therewith, the coupling plug is electrically connected to the control board, and the control board is connected to an external power supply through a power cord;
a thermal protector and a temperature sensor are disposed in the inner cavity of the housing component, a heating film is disposed in the flexible heating pad, the coupling socket is respectively electrically connected to the thermal protector, the temperature sensor, and the heating film; and
the heating member is disposed above or below the thermal protector and the temperature sensor.

12. The sealed and waterproof warming tray according to claim 11, wherein the coupling socket comprises electrical terminals, the coupling plug comprises electrical contact portions, the electrical terminals are inserted into and electrically connected to the electrical contact portions.

13. The sealed and waterproof warming tray according to claim 12, wherein the upper housing body and the lower housing body defines a second mounting hole therebetween, the second mounting hole is disposed corresponding to the first mounting hole, the second mounting hole is configured to accommodate the coupling socket; and
the control box defines a third mounting hole corresponding to the second mounting hole, and the third mounting hole is configured to accommodate the coupling plug.

14. The sealed and waterproof warming tray according to claim 6, wherein the heating member comprises at least one wiring terminal, the at least one wiring terminal extends into the inner cavity of the housing component, and first wiring extending externally from the at least one wiring terminal is electrically connected to the coupling socket.

15. The sealed and waterproof warming tray according to claim 14, wherein the inner cavity comprises at least one second fixing post, a thermal insulation member is sleeved on the at least one second fixing post, the thermal insulation member is disposed between the at least one wiring terminal and the at least one second fixing post to separate the at least one wiring terminal and the at least one second fixing post;
a connecting portion is disposed between the at least one wiring terminal, the thermal insulation member, and the at least one second fixing post, and the connecting portion is configured to connect the at least one wiring terminal, the thermal insulation member, and the at least one second fixing post;
the connecting portion comprises a third fixing hole defined on the at least one wiring terminal, a fourth fixing hole defined on the thermal insulation member, and a fifth fixing hole defined on the at least one second fixing post, a screw sequentially passes through the third fixing hole and fourth fixing hole to fixedly connect to the fifth fixing hole, so as to connect the at least one wiring terminal, the thermal insulation member, and the at least one second fixing post.

16. The sealed and waterproof warming tray according to claim 11, wherein the flexible heating pad defines a fourth mounting hole and a fifth mounting hole, the temperature sensor is disposed in the fourth mounting hole, and the thermal protector is disposed in the fifth mounting hole; and
the heating member is disposed above the thermal protector and the temperature sensor, the thermal protector and the temperature sensor are pressed into the heating member to a depth of a, where the a is ranged from 0.8 mm to1.5 mm.

17. The sealed and waterproof warming tray according to claim 16, wherein the coupling socket and the coupling plug form a coupling portion, the coupling portion is partially disposed in the inner cavity, the fourth mounting hole is communicated with the inner cavity, the temperature sensor partially extends into the inner cavity, first connection terminals extend from one end, extending into the inner cavity, of the temperature sensor, and first wiring extending externally from the first connection terminals is electrically connected to coupling portion.

18. The sealed and waterproof warming tray according to claim 17, wherein second connection terminals are disposed on the thermal protector, the fifth mounting hole is communicated with the inner cavity, the second connection terminals extend into the inner cavity, and second wiring extending externally from the second connection terminals is respectively electrically connected to the coupling portion and the heating member.

19. The sealed and waterproof warming tray according to claim 16, wherein the flexible heating pad comprises a protruding portion, the fourth mounting hole and the fifth mounting hole are defined on the protruding portion, the housing component defines a limiting hole, the protruding portion passes through the limiting hole and extends into the inner cavity.

20. The sealed and waterproof warming tray according to claim 1, wherein the flexible heating pad comprises a planar heating pad body, the heating member is disposed in the planar heating pad body, a thickness of the planar heating pad body is b, and the b is ranged from 2 mm to 4 mm; and
the heating member is a carbon crystal heating film, the carbon crystal heating film is sheet-shaped and has a thickness less than 30 μm.
